(19) United States
(12) Patent Application Publication
(10) Pub. No.: US 2006/0048468 A1
(43) Pub. Date: Mar. 9, 2006

(54) Insulating glazing

(75) Inventors: Yves Demars, Agnetz (FR); Jean-Pierre Douche, Le Plessis Brion (FR); Jean-Christophe Elluin, Choisy Au Bac (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/530,060

(22) PCT Filed: Oct. 15, 2003
(86) PCT No.: PCT/FR03/03033

§ 371 Date: Apr. 4, 2005

(30) Foreign Application Priority Data
Oct. 17, 2002 (FR) 02/13028

(51) Int. Cl. E06B 7/00; E06B 9/01

(52) U.S. Cl. 52/204.6; 52/204.591

(57) ABSTRACT

An insulating glazing panel including at least two glass panes separated by a gas space. A spacer serves to keep the two glass panes apart and having at least one approximately flat strip fitted at least partly around the perimeter of the glazing panel and fixed by adhesive bonding using a fastener. The strip is fitted substantially toward the interior of the panel set back with respect to at least one end face of a glass pane and is adhesively bonded against at least one internal face of a glass pane.

The subject of the invention is an insulating glazing panel.

One well-known type of insulating glazing panel comprises two glass panes that are separated by a gas space, such as an air space, and are joined together but kept apart by means of a spacer frame consisting of hollow metal strips folded or assembled by corner pieces. The strips are provided with a molecular sieve whose role in particular is to absorb the water molecules that are trapped within the airspace during manufacture of the glazing panel, or that would subsequently penetrate thereinto and be liable to condense in cold weather, causing the appearance of fogging.

To seal the glazing panel, the spacer frame is adhesively bonded to the glass panes by a bead of elastomer of the butyl rubber type applied directly to the strips by extrusion through a nozzle. Each corner of the spacer frame is also provided in the angle piece with butyl rubber. Once the glazing panel has been assembled, the elastomer sealing bead acts as temporary mechanical retention of the glass panes. Finally, a crosslinkable mastic sealant, of the polysulfuride, polyurethane or silicone type, is injected into the peripheral groove bounded by the two glass panes and the spacer frame, which sealant completes the mechanical assembly of the glass panes. The role of the butyl rubber is mainly to seal the interior of the glass pane from water vapor and gases, whereas the mastic seals against solvents or liquid water.

The manufacture of this glazing panel requires several separate materials, including strips, angle pieces, molecular sieve and organic seals, these materials not being brought together in one and the same operation.

One drawback of such a manufacture is that of storing the materials. In order to be operational for any new order placed for insulating glazing panels, many batches of each material must be available, which does not contribute to simple and rapid management as regards the provisioning and storage of these materials.

Furthermore, the actual number of materials to be brought together involves several mounting operations which, although automated, are carried out one after another, which appreciably lengthens the manufacturing time. Some of these operations also cause interruptions in the manufacturing line, which can as a result of these short dead times further reduce the productivity.

In addition, regeneration of the molecular sieve lining the inside of the hollow strips is impossible with the insulating glazing panels known at the present time as it involves destroying them.

Another solution for keeping the two glass panes of an insulating glazing panel apart is that disclosed in French patent FR 2 115 932. In that document, the glass panes are kept apart by a spacing piece and joined together by soldering by means of a metal tape, the spacing piece furthermore preventing the metal tape from buckling. The operation of joining the glass panes together by soldering the metal tape, which is made of lead, is carried out in regions of the internal faces of the glass panes that are provided with a tinned copper coating.

This solution has the disadvantage of using at least two pieces—the spacing piece and the metal tape—for keeping the glass panes apart and for joining them together. Furthermore, the metal tape is fixed by soldering, the glass panes having been precoated with a copper portion. In addition, this method employs expensive means, such as the use of two pieces, and the use of copper, and it is not simple to implement.

To obviate these drawbacks, French patent applications FR 2 807 783 and FR 01/13354 propose an insulating glazing panel the choice of the materials and the arrangement of the spacer of which make it easier to manage the glazing panel manufacturing flow, to simplify the assembly operations and to restore the glazing panel without destroying it, especially by replacement of the molecular sieve and/or reintroduction of gas, thereby also making it possible to reduce the production costs.

Thus, the spacer consists of an approximately flat strip that is fixed to the glass panes via its internal face, being pressed against the end faces of the glass panes. This strip need not be placed over the entire perimeter of the glazing panel in order at least to fulfill its spacer role, but only over a part, the other part of the perimeter of the glazing panel being surrounded by another strip intended to provide various functionalities. This other strip may, for example, be hollow in order to contain the molecular sieve, the easy bonding and debonding of the substantially flat strip constituting the spacer allowing easy access to the hollow strip in order to replace the sieve. This other strip may also have a shape suited to the fitting and/or fastening of the glazing panel in the opening for which it is intended.

The configuration and the material of the spacer therefore permit it to be positioned along the end faces of the glass panes, which moreover increases the visibility through the glazing panel.

The object of the invention is to propose another solution of fitting the substantially flat spacer described above in a single or multiple insulating glazing panel, while not significantly impairing the daylight obtained by the disposition of this type of spacer and by providing all the sufficient inertness to the glazing panel.

According to the invention, the insulating glazing panel comprising at least two glass panes separated by a gas space, a spacer serving to keep the two glass panes apart and having at least one approximately flat strip fitted at least partly around the perimeter of the glazing panel and fixed by adhesive bonding using fastening means, characterized in that the strip is fitted substantially toward the interior of the panel set back with respect to at least one end face of a glass pane and it is adhesively bonded against at least one internal face of a glass pane.

According to one feature, the fastening means constitute means for sealing with respect to the interior of the panel.

Advantageously, the fastening means cover, on the outside of the glazing panel, on the opposite side from the gas space, at least the respective edge(s) of the strip that are contiguous with the internal faces of the glass panes. As a variant or additionally, the fastening means are positioned along the end face(s) of the strip that are placed against the internal faces of the glass panes and optionally extend toward the interior of the panel on the gas space side.

According to one embodiment of the glazing panel, the glass panes have, on at least one of their sides with the strip, their end faces level.

According to another embodiment, the glass panes have, on at least one of their sides with the strip, their end faces offset levelwise, one of the panes being larger than the other, and the strip rests, on the one hand, via one of its end faces against the internal face of the larger of the panes and, on the other hand, via its opposite end face against the internal face of the other pane and level with the end face of said pane or set back toward the interior of the panel with respect to the end face of said pane.

According to yet another embodiment, the glass panes have, on at least one of their sides with the strip, their end faces offset levelwise and the strip rests, on the one hand, via its internal face against the end face of the glass pane offset toward the interior of the panel and, on the other hand, via one of its end faces against the internal face of the other glass pane, the fastening means covering, on the one hand, the end face of the glass pane offset toward the interior of the panel and, on the other hand, the edge of the strip contiguous with the other glass pane or the end face of the strip placed against the internal face of the other glass pane.

According to another feature, the fastening means consist of an adhesive of the hot-melt type. Preferably, the adhesive resists tear stresses of at least 0.45 MPa.

Advantageously, the material(s) forming the strip constitute means for sealing with respect to the interior of the panel. The strip has a buckling strength per unit length of at least 400 N/m. Furthermore, the strip may have, on one or both of its faces, functional elements obtained by forming in the material of the strip.

Other features and advantages will be described in the rest of the description in conjunction with the drawings in which:

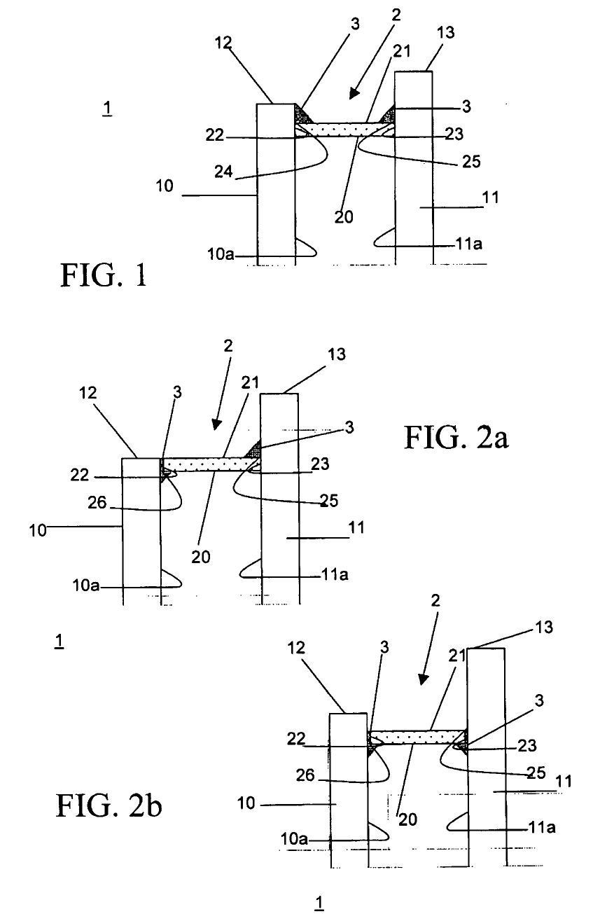

FIG. 1 illustrates a partial sectional view of the placement of the spacer in a first type of insulating glazing panel;

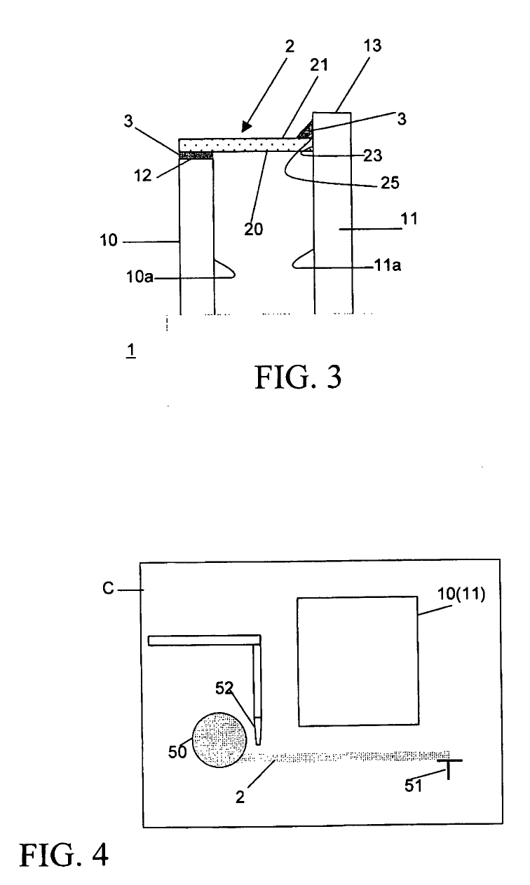

FIGS. 2a, 2b and 3 illustrate partial sectional views according to alternative embodiments of the fitting of the spacer in a second type of insulating glazing panel; and

FIG. 4 shows schematically the plant for manufacturing the glazing panel.

FIGS. 1 to 3 show alternative embodiments of a simple insulating glazing panel 1 according to the invention.

The glazing panel 1 comprises two glass panes 10 and 11, separated by a gas space 12, and a spacer 2 that serves to keep the two glass panes apart and has the function of providing mechanical retention of the glazing assembly.

Sealing means (not illustrated) intended to seal the glazing panel against liquid water, solvents and water vapor, are provided, these being joined to the spacer in the form of a metal coating or a stainless steel type coating, when the spacer is made of plastic, or consist of the spacer itself if this is made of metal. There is no need to add, as in the prior art, an additional joining and sealing material of the mastic type.

The flat strip ensures mechanical assembly of the glazing panel owing to the fastening means 3 that ensure complete adhesive bonding to the glass.

The spacer 2 is in the form of a substantially flat strip about 1 nm in thickness and of approximately parallelepidal cross section, having an internal face 20 facing the gas space and an opposed external face 21. Advantageously, this strip is of low mechanical inertia, that is to say it can be easily wound up with a small winding radius, for example 10 cm.

It is unnecessary for the flat strip to be placed around the entire periphery of the glazing panel—the spacer of the glazing panel may also include, for example, on one side of the panel, another means of sealing the glass panes or else another strip that is not necessarily flat and may exhibit various functionalities. Reference may be made to French patent application FR 01/13354 regarding the possible ways of fitting this other strip and its possible functionalities, which strip is denoted in that document by the term “other strip”.

The width of the strip 2 is matched to the thickness of the gas space 12 of the glazing panel.

The strip is strong enough to fulfill the function of mechanically keeping the two glass panes apart. Its strength is defined by the very nature of its constituent material, the buckling strength per unit length of which must be at least 400 N/m.

Moreover, the nature of the material of said strip is also chosen so that, during the process of manufacturing the glazing panel, the strip may be sufficiently flexible for the operation of fitting it between the glass panes to be carried out by bending it around the corners.

The flat strip may be made entirely of metal, the chosen material being preferably stainless steel or aluminum. During the process, the fitting of the strip around the corners is carried out by bending using machines well known to those skilled in the art of conversion of metallic materials.

To guarantee a minimum buckling strength per unit length of 400 N/m, the spacer must have a thickness of at least 0.1 mm in the case of stainless steel and of 0.15 mm in the case of aluminum.

As a variant, the flat strip 2 is based on a plastic which may or may not be reinforced with chopped or continuous reinforcing fibers. Thus, a material may be styrene acrylonitrile (SAN) combined with chopped glass fibers, for example the material sold under the name LURAN® by BASF, or else polypropylene reinforced with continuous glass fibers, sold under the name TWINTEX® by Saint-Gobain Vetrotex.

It should be noted that in the case of a plastic that is a thermoplastic, the bending around the corners of the glazing panel is performed after softening the material, and may be carried out more easily than with an entirely metallic material.

Moreover, when using a plastic, it may be highly advantageous for the desiccant to be intrinsically incorporated, partly or completely, in the strip, which is impossible with metal. The desiccant may be a molecular sieve, such as a powdered zeolite, the proportion of which may be up to 20% by weight or about 10% by volume. The amount of desiccant depends on the desired lifetime to be assigned to the glazing panel.

Finally, since a plastic is less thermally conductive than a metal, the thermal insulation of the entire glazing unit can only be better when, for example, the glazing panel is exposed to a very cold climate.

As regards the addition of glass fibers to the plastic, this results in a thermal expansion coefficient of the material that is much lower than that of a pure plastic and becomes close to the coefficient of glass, thereby causing, when the gas space is exposed to a thermal variation, a lower shear force on the fastening means 3.

To ensure a strength per unit length of 400 N/m, the spacer 2 has a thickness of at least 0.2 mm when it is made of a fiber-reinforced thermoplastic.

If the flat strip is essentially made of plastic, such as a reinforced plastic, its external face 21 is covered with a protective metal coating of the aluminum or stainless steel foil type, with a thickness of between 2 and 50 μm, this coating constituting the sealing means. Apart from its sealing role, the foil, in particular when it is made of stainless steel, provides the strip with effective protection against abrasion, for example when it is being handled or transported. Finally, it promotes heat exchange with the thermoplastic when the latter has to be softened during the manufacturing process.

As a variant, the metallic coating may be wide enough to cover the external face 21 and be folded down over the edges of the internal face 20.

In another variant, the spacer may be made up of a combination of materials, such as a metal and a plastic.

The numbers given above for the thickness of the spacer depending on the nature of the material used are for a buckling strength per unit length of 400 N/m, which is a conventional value for glazing panels of the most common dimensions, namely 1.20 m by 0.50 m. However, to extend the use to larger panels and/or to panels subjected to extreme stressing conditions, it will be preferable to design panels whose spacer is capable of withstanding a force of 5 700 N per linear meter. To achieve such a buckling strength, we give below a table indicating the calculated safety factor relative to the 5 700 N/m reference as a function of the corresponding thicknesses to be given to the spacer of the invention depending on the type of material.

| Safety | Acrylonitrile | | Stainless |
|---|---|---|---|
| factor | styrene (SAN) | Aluminum | steel |
| 1 | 0.50 mm | 0.25 mm | 0.20 mm |
| 3 | 0.75 mm | 0.40 mm | 0.30 mm |
| 4.5 | 0.90 mm | 0.45 mm | 0.35 mm |

The internal face 20 of the flat strip that is intended to face the gas space 12 may have, in its central part, the properties of those of a desiccant for the purpose of absorbing the water molecules that may be trapped in the gas space. These desiccant properties may result from the nature of the material of the spacer, the actual composition of which incorporates a molecular sieve. As a variant, the desiccant element may instead be obtained by depositing a molecular sieve on the central part of the internal face before the strip is fitted between the glass panes of the glazing panel.

In an alternative embodiment, the desiccant may be incorporated not in the flat strip but in a hollow strip that is joined to the glazing panel, the cavity of the hollow strip facing the gas space. The flat strip is in this case not placed around the entire perimeter of the panel, or else the flat strip is fastened to this hollow strip. For further details, reference may be made to French patent application FR 01/13354, in particular regarding FIGS. 1b, 1c and 1d of that application.

We should point out that the substantially flat strip may include, on one or both of its faces, functional elements obtained by forming in the material of the strip or attached by fastening to the strip. As regards these functional elements, reference may be made to French patent application FR 01/13354.

In FIG. 1, the two glass panes 10 and 11 of the glazing panel have identical dimensions in respect of the sides that incorporate the flat strip as spacer, that is to say that the end faces 12, 13 of the glass panes are level. The strip 2 is placed between the two glass panes set back toward the interior of the panel relative to the end faces 12 and 13 of the glass panes, the end faces 22 and 23 of the strip resting against the internal faces 10a and 11a of the glass panes.

FIGS. 2a, 2b and 3 show a glazing panel whose glass panes have different dimensions at least as regards one side, that incorporating the flat strip as spacer; this glazing is referred to as having offset panes. One of the panes is, on at least one side of the glazing panel, smaller than the other, the end faces 12, 13 of the glass panes then not being level.

In FIGS. 2a and 2b, the flat strip 2 is joined to the glass panes via its end faces 22, 23, one of the end faces 23, being pressed against the internal face 11a of the larger of the panes, set back toward the interior of the panel and level with the end of the opposed smaller pane in the case of FIG. 2a or set back relative to the end face 12 of the smaller pane in the case of FIG. 2b, whereas the other end face 22 is pressed against the internal face 10a of the smaller pane, the external face 21 of the strip being level with the end face 12 of the smaller glass pane 10 (FIG. 2a) or set back toward the interior of the panel relative to the end face 12 (FIG. 2b).

In FIG. 3, the flat strip is joined to the glass panes via one of its end faces 23 and part of its internal face 20, the end face 23 being pressed against the internal face 11a of the larger of the panes, set back toward the interior of the panel and level with the end of the opposed smaller pane 10, whereas the opposed lateral end of the strip is pressed via its internal face 20 against the end face 12 of the smaller pane 10.

The fastening means 3, that ensure adhesion of the spacer to the glass, are formed by an adhesive impermeable to gases and to water vapor. They form complementary sealing means. Tests carried out in accordance with United States Standard ASTM 96-63T on adhesive specimens 1.5 mm in thickness have shown that an adhesive with a water vapor permeability coefficient of 35 g/24 h.m² such as that of a silicone is suitable. Of course, an adhesive having a permeability coefficient of 4 g/24 h.m², such as that of polyurethane, or even lower, is more suitable since, because it has even better sealing, a smaller amount of desiccant then has to be provided.

It will also be judicious to adapt the nature of the adhesive to the operating environment of the glazing panel; thus, the adhesive will, for example, have to exhibit sufficient temperature resistance for application of the panel in the door of a domestic oven.

The adhesive must also withstand being debonded by liquid water, by ultraviolet radiation and by loads that may be exerted perpendicular to the faces of the panel, usually called shear stresses, and by loads exerted parallel to the force of the glazing panel's weight. A satisfactory adhesive must withstand tear stresses of at least 0.45 MPa.

Finally, the adhesive must have rapid adhesion properties, in a few seconds, in order to fasten the strip as soon as the latter has been joined to the glass panes; such an adhesive is one that sets by chemical reaction, possibly activated by heat or by pressure, or else sets by cooling if the adhesive consists of a thermoplastic of the hot-melt type, for example one based on a polyurethane that can crosslink by the moisture in the air.

In the embodiment shown in FIG. 1, the adhesive 3 is placed along the edges 24, 25 of the strip that are contiguous with the glass panes on the outside of the glazing panel. Adhesive may also be placed along the end faces 22, 23 of the spacer and extend toward the interior of the panel on the gas space side, depending on the method of assembly carried out (as may be seen in FIG. 2b in the case of the fastening means 3 joined to the pane 11).

In the embodiment shown in FIGS. 2a and 2b, the adhesive 3 is placed, on the one hand, along the edge 25 contiguous, with the larger glass pane 11 on the outside of the glazing panel and, on the other hand, along the end face 22 fastened to the other glass pane 10 and along the edge 26 contiguous with the smaller glass pane 10 on the inside of the glazing panel on the gas space side. Depending on the method of assembly chosen, the adhesive joined to the large glass pane 11 may also be placed along the end face 23 of the strip and possibly extend toward the interior of the panel on the gas space side (FIG. 2b).

In the embodiment shown in FIG. 3, the adhesive 3 is placed, on the one hand, along the edge 25 contiguous with the larger glass pane 11 on the outside of the glazing panel and, on the other hand, along that part of the internal face 20 fastened to the end face 12 of the other glass pane 10. Depending on the method of assembly chosen, the adhesive joined to the large glass pane 11 may also be placed along the end face 23 and possibly extend toward the interior of the panel on the gas space side (as may be seen in FIG. 2b in the case of the fastening means 3 joined to the pane 11).

The manufacturing process will now be described by way of example in conjunction with FIG. 4 that schematically illustrates the plant for implementing it. Alternative embodiments may be envisioned.

The glass panes 10 and 11 are brought in, on edge, by standard means to a chamber C that may contain the gas to be introduced into the glazing panel.

The glass panes 10 and 11 are held on edge with the desired separation, for example by means of suckers placed on the external faces of the glazing panel and controlled by pneumatic cylinders (not illustrated).

The strip 2 is stored on a reel 50 and is unwound and drawn in the form of a tape. A mechanical arm 51 controlled by electronic control means is used to guide the strip and take it to the desired point.

The adhesive 3, which as explained above is a rapid-setting adhesive, is delivered by feed means 52.

In the case of the embodiment shown in FIG. 1, two alternative methods of assembly may be distinguished.

According to a first method of assembly, the strip 2 is applied via one of its end faces against one of the glass panes; while keeping the strip in position, the other pane is brought up against the free end face of the strip. The whole assembly is kept clamped and adhesive 3 is injected along the edges 24 and 25.

According to a second method of assembly, adhesive 3 is deposited on and around the periphery of the internal face 11a of one of the glass panes or else on one of the end faces 23 of the strip, then the strip 2 is brought up via its end face 23 against the glass pane, the adhesive being placed along the end face 23 and being able to extend beyond the edge 25 and/or toward the interior of the panel on the gas space side. The other glass pane is then brought up against the free end face 22 of the strip, and adhesive 3 is delivered along the edge 24. Finally, the whole assembly is firmly clamped in order to ensure perfect adhesion.

In the case of the embodiment shown in FIGS. 2a and 2b, the strip 2 is adhesively bonded via one of its end faces 23 against the internal face 11a and to the periphery of the larger of the glass panes and set back relative to its end face, the adhesive having been deposited beforehand along the end face of the strip or else on the glass pane in the bonding region. Adhesive is then delivered either along the free end face 22 of the strip or on the internal face 10a of the other glass pane, and the other glass pane 10 is brought up against the free end face 22 of the strip. Finally, the whole assembly is clamped while the adhesive sets.

In the case of the embodiment shown in FIG. 3, adhesive is delivered against the end face 12 of the smaller glass pane 10 or else against the face 20 of the strip in the end region to be adhesively bonded to the end face of the glass pane 10, and the strip is brought up against the end face 12 of the glass pane 10. Next, adhesive is applied against the internal face 11a of the other glass pane 11 toward its periphery set back toward the interior of the panel, and the free end face of the strip joined to the first glass pane is pressed against said pane 11 and the whole assembly is clamped. As a variant, once the strip has been joined to the first glass pane, this combination is pressed against the other glass pane, the whole assembly is kept clamped and adhesive is delivered along the edge 25.

When the strip is fitted along more than one side of the glazing panel, the placing of the spacer around the corners of the glazing panel and its fastening are carried out in the same way as described above, except that, as the strip is being delivered by the device 51, the latter bends the strip by suitable means.

As a variant, in order to fill the glazing panel with the gas that is to be contained therein, instead of using a gas-filled chamber, a gas feed device is provided, such as a hose that is inserted between the two glass panes and delivers gas as the edges of the glazing panel are being surrounded and sealed. The device is removed just before the last side of the panel is sealed off.

1-12. (canceled)

13. An insulating glazing panel comprising:
at least two glass panes separated by a gas space;
a spacer configured to keep the two glass panes apart and including at least one approximately flat strip fitted at least partly around a perimeter of the glazing panel and fixed by adhesive bonding using a fastener,
wherein the strip is fitted substantially toward an interior of the glazing panel set back with respect to at least one end face of one of the glass panes and is adhesively bonded against at least one internal face of the one glass pane.

14. The glazing panel as claimed in claim 13, wherein the fastener includes means for sealing with respect to the interior of the glazing panel.

15. The glazing panel as claimed in claim 13, wherein the fastener covers, on an outside of the glazing panel, on an opposite side from the gas space, at least any respective edge of the strip that is contiguous with internal faces of the glass panes.

16. The glazing panel as claimed in claim 13, wherein the fastener is placed along an end face of the strip that is placed against internal faces of the glass panes and extends toward the interior of the glazing panel on the gas space side.

17. The glazing panel as claimed in claim 13, wherein the glass panes have, on at least one of their sides with the strip, their end faces level.

18. The glazing panel as claimed in claim 13, wherein the glass panes have, on at least one of their sides with the strip, their end faces offset levelwise, one of the glass panes being larger than the other, and the strip rests via one of its end faces against the internal face of the larger of the glass panes and, via its opposite end face against the internal face of the other glass pane and level with the end face of the other glass pane or set back toward the interior of the glazing panel with respect to the end face of the other glass pane.

19. The glazing panel as claimed in claim 13, wherein the glass panes have, on at least one of their sides with the strip, their end faces offset levelwise and the strip rests via its internal face against the end face of the glass pane offset toward the interior of the glazing panel and, via one of its end faces against the internal face of the other glass pane, the fastener covers the end face of the other glass pane offset toward the interior of the glazing panel and, the edge of the strip contiguous with the other glass pane or the end face of the strip placed against the internal face of the other glass pane.

20. The insulating glazing panel as claimed in claim 13, wherein the fastener includes an adhesive of hot-melt type.

21. The insulating glazing panel as claimed in claim 20, wherein the adhesive resists tear stresses of at least 0.45 MPa.

22. The insulating glazing panel as claimed in claim 13, wherein a material forming the strip includes means for sealing with respect to the interior of the glazing panel.

23. The insulating glazing panel as claimed in claim 13, wherein the strip has a buckling strength per unit length of at least 400 N/m.

24. The insulating glazing panel as claimed in claim 13, wherein the strip includes, on one or both of its faces, functional elements formed in a material of the strip.
